(19) United States
(12) Patent Application Publication
(10) Pub. No.: US 2004/0172467 A1
(43) Pub. Date: Sep. 2, 2004

(54) Method and system for monitoring a network

(76) Inventors: Gabriel Wechter, Fort Collins, CO (US); Eric A. Pulsipher, Fort Collins, CO (US); Tyler G. Peterson, Fort Collins, CO (US); Srikanth Natarajan, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/375,362

(22) Filed: Feb. 28, 2003

(51) Int. Cl. G06F 15/173

(52) U.S. Cl. 709/224

(57) ABSTRACT

An exemplary method for monitoring a network includes detecting changes in the network, and initiating discovery of the topology of the network when a number of the detected changes in the network exceeds a threshold. Another exemplary method includes initiating discovery of the topology of the network when a predetermined time period expires.

### BACKGROUND

In network topology discovery products, new network nodes can be discerned. However, the discovery of new nodes is not an accurate means of tracking changes to a network topology for the purpose of threshold-based discovery. For example, other changes in the network may not be discerned or tracked, resulting in a stale and inaccurate network topology representation that has an unknown and unbounded level of inaccuracy. There is no mechanism to guarantee that topology data remain current within a bounded deviation from the latest known actual network topology. Such inaccuracy is particularly pronounced in dynamic network environments. U.S. Pat. No. 6,405,248 and No. 6,108,702 describe monitoring systems for determining accurate topology features of a network.

### SUMMARY

An exemplary method for monitoring a network includes detecting changes in the network, and initiating discovery of the topology of the network when a number of detected changes in the network exceeds a threshold. An exemplary machine readable medium includes software or a computer program for causing a computer or computing device to perform the exemplary method. An exemplary system for monitoring a network includes means for detecting changes in the network, and means for initiating discovery of the topology of the network when a number of detected changes in the network exceeds a threshold.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates a functional block diagram in accordance with an exemplary embodiment.

FIG. 2 illustrates an exemplary method.

### DETAILED DESCRIPTION OF THE EXEMPLARY EMBODIMENTS

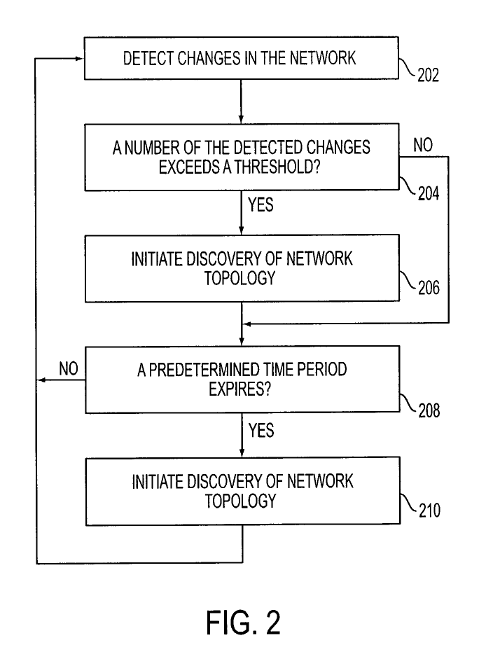

FIG. 2 illustrates an exemplary method for monitoring a network, for example monitoring a need to update a network topology. The exemplary method includes detecting changes in the network (block 202), for example changes in topology or configuration of a network, determining whether a number of detected changes in the network exceeds a threshold (block 204), and initiating discovery of the topology of the network (block 206) when the number of detected changes exceeds the threshold. When the number does not exceed the threshold, control proceeds from block 204 directly to block 208. The exemplary method can also include determining whether a predetermined time period has expired (block 208), and initiating discovery of the topology of the network (block 210) when the predetermined time period expires. From block 210 control can return to block 202, so the cycle can begin anew. If in block 208 it is determined that the time period has not expired, then control returns from block 208 to block 202 and the cycle continues. The predetermined time period can be reset after it expires, for example after the block 210, and can be reset each time when, or after, discovery is initiated (for example, the time period can be reset between blocks 206, 208). The number of detected changes can be reset after reaching the threshold, for example after the block 206, and can be reset each time when, or after, discovery is initiated (for example, the number of detected changes can be reset to zero after block 210).

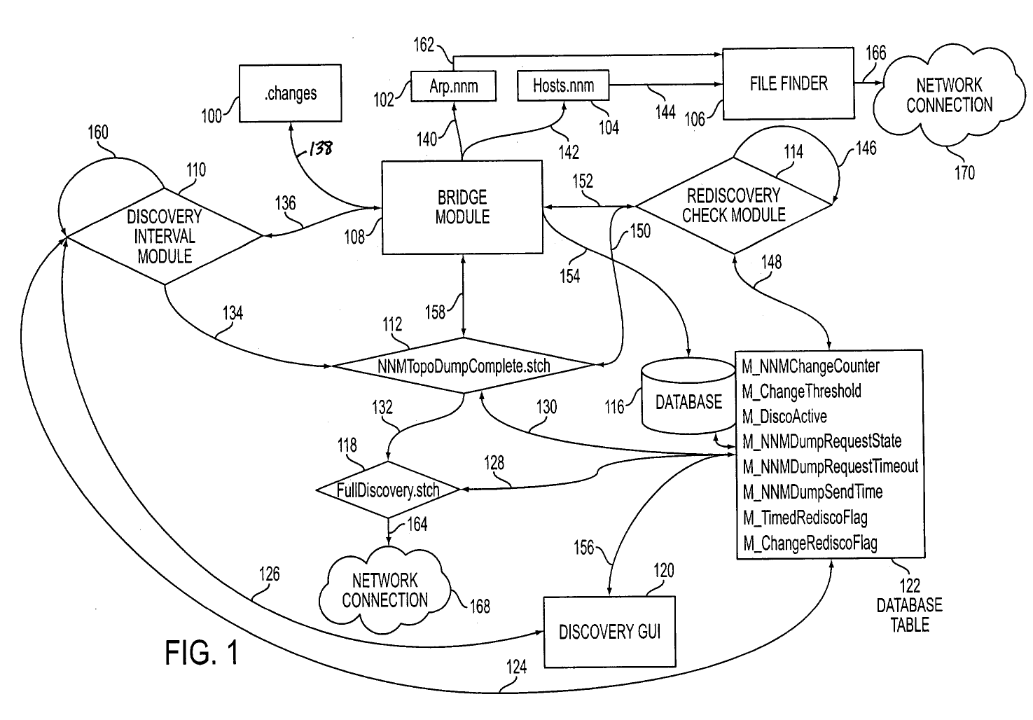

FIG. 1 is a functional block diagram illustrating exemplary implementations of various aspects of the method illustrated in FIG. 2. For example, FIG. 1 shows a bridge module 108 that detects and stores or keeps a record or number of the detected changes in the network, such as changes in topology or configuration of the network. For example, the bridge module 108 can store the detected changes or number of changes in a database 116, via a link 154. Exemplary changes in topology or configuration of the network, or in other words “delta events” in the network, that can be detected and counted by the bridge module 108 include: addition of a new node to the network; deletion of a node from the network topology; addition of a new interface to the network; and deletion of an interface from the network; and change in status of a node or interface in the network, for example if the node or interface changes from active status to inactive or down status, or changes from inactive to active status. Other exemplary changes can include (but are not limited to): change of a node name; a node becoming managed; a node becoming un-managed; change in a node's Object ID (OID); change in a node's Connector properties; change in a node's Gateway properties; a node changing to, or being found to, support SNMP (Simple Network Management Protocol); change in a node's forwarding table (including for example paths via which the node forwards data); changes in a node's SNMP address; changes in SNMP community strings used to access one or more nodes in the network; changes in the finding of a new network or subnet; the deletion of a network or subnet from the topology; new or changed connections between devices in the network; and so forth.

The database 116 can include a database table 122. A rediscovery check module or stitcher (e.g., an entity that can receive and convey information, and also reformat or process the information) 114 linked to database 116 (and the database table 122) via a link 148 and linked to the bridge module 108, can monitor the number of detected changes in topology or configuration and detect when the number of detected changes exceeds a threshold. The threshold can be configurable, for example by a user. When the rediscovery check module 114 detects that the threshold has been exceeded, it can notify the bridge module 108 of this event via the link 152, and can also notify a module 112 via a link 150, for example in the event that communication to or from the bridge module 108 fails or the function of the bridge module 108 fails to complete within a given timeout threshold. When the bridge module 108 has completed producing updated network data to be used in an upcoming network topology discovery operation, dumping this data to files, and resetting or updating the count of detected network changes, for example to the database 116 via the link 154 and/or to modules 100, 102, 104 via links 138, 140, 142, respectively, the bridge module 108 alerts the module 112 via a link 158 that storage operations are (at least temporarily) complete. When the module 112 discerns that storage operations are complete and a rediscovery operation is desired (e.g., because the rediscovery check module 114 reports that the threshold number of detected changes has been exceeded), the module 112 triggers a discovery operation by sending a message or instruction to a module 118 via a link 132, so that the module 118 performs a full discovery operation on the network.

In accordance with an exemplary embodiment, discovery of the topology of the network can also be initiated or enabled upon expiration of a predetermined time period, at a predetermined time interval, or at a predetermined time. For example, a discovery interval module 110 can determine when a predetermined time period or a predetermined time interval expires, or when a predetermined time arrives, and can alert the bridge module 108 via a link 136 and can alert the module 112 via a link 134 when this event occurs. The discovery interval module 110 can also communicate with the database 116 (including the database table 122) via a link 124, for example in the event that communication to or from the bridge module 108 fails or the function of the bridge module 108 fails to complete within a given timeout threshold.

A Graphical User Interface (GUI) 120 can also be provided. A user can use the GUI 120 to communicate with the discovery interval module 110 via a link 126 to specify, set or delete the time period, time interval/frequency, or specific time that the discovery interval module 110 monitors and detects. A user can also use the GUI 120 to set a threshold for the rediscovery check module 114, for example by changing the M_ChangeThreshold value in the database table 122 via the link 156. This allows the user to set known, guaranteed bounds on the divergence of the data produced by the last discovery cycle or network topology discovery operation, and automatically initiate a discovery operation to capture the latest data or topology. The discovery process can be triggered based on a number of detected changes in the network, based on a time period, time interval, or specific time, based on both time and detected changes, or based on neither.

The GUI 120 can communicate with the database 116, including the database table 122, via a link 156. The modules 112, 118 can also communicate with the database 116 and the database table 122, via links 130, 128 respectively, for example to update variables regarding the state of the network topology discovery operation and the discovery initiation process.

In an exemplary embodiment, the bridge module 108 monitors for and intercepts select network topology changes or “delta events”, for example in real-time as they occur. Exemplary changes include when a switch interface goes down or comes back up, when a new node is added to the network, when a node is removed from the network, and so forth. The bridge module 108 can track and record or store (for example, with the assistance of the database 116) differences between a present form of the network and a latest network topology that was output based on a latest network topology discovery operation (performed for example by the module 118).

The bridge module 108 can for example increment or update a change or difference counter such as the M_NNMChangeCounter variable in the database table 122, at periodic intervals or whenever the bridge module 108 detects a change in the network. The bridge module 108 can also provide information regarding changes in the network since a last network topology discovery operation, in response to requests from other modules such as the modules 110, 114. The modules 110, 114 can for example request the bridge module 108 to provide information regarding changes in the network since a last network topology discovery operation, when the modules 110, 114 indicate that a new network topology discovery operation should be commenced or enabled (for example, upon expiration of a time interval or achievement of a threshold number of network changes). The bridge module 108 can provide the requested information so that the information can be used as seed information for the discovery operation. In other words, the information can be used as a starting point or priority list by the discovery operation, or can be used as valid topology information that does not need to be rediscovered or redetermined. To this end, the information can be provided to agents or modules such as the modules 102, 104, that then provide the information via links 162, 144 to a file finder module 106 that works in conjunction with the module 118 to perform a new network topology discovery operation that will discern a topology of the network and return a representation of the discerned topology. For example, the module 118 can request the file finder module 106 to refresh a database (not shown) accessible to or located within the module 118, for example when it is time for a rediscovery operation to occur. The file finder 106 can link to other elements or communication paths in the network, for example via a link 166 connected to a network connection 170, and the module 118 can link to other elements or communication paths in the network (for example, the database that is refreshed by the file finder 106) via a link 164 connected to a network connection 168. The request from the module 118 to the file finder 106 can, for example, be conveyed via the network and the links 164, 166 between the module 118 and the file finder 106.

A request from the module 118 causes the file finder module 106 to obtain a fresh list or set of devices in the network to discover or query. The file finder module 106 can obtain the list or set via a ping tool, from a Hewlett Packard Network Node Manager (NNM) in the network, from information provided (seeded) by a user, or via any other mechanism. The file finder module 106 can inject the corresponding device records or device list contents into a discovery data flow, for example a discovery data flow of the module 118, to initially guide or seed the network topology discovery operation. For example, a Layer 2 discovery add-on mechanism to the NNM can cause the NNM to provide a device list or file (such as the “Hosts.nnm” module 104 or element 104) to the file finder module 106, which then injects the information into the discovery data flow. This information can be used as a starting point for the network topology discovery operation. Alternatively, the information can be used as valid topology information that need not be rediscovered or redetermined, so that the scope of the network topology discovery operation can be limited to only those areas of the topology whose status or configuration is not currently known or verified. In an exemplary embodiment, the bridge module 108 can use an NNM in the network to detect changes in the network that are counted and/or tracked.

The “Arp.nnm” module 102 and the “Hosts.nnm” module 104 can be files of information that the bridge module 108 found during its monitoring, for example via an NNM. Specifically, the module 102 can contain a list of found or known nodes in the network, and the module 104 can contain information on ARP (Address Resolution Protocol) found by the monitoring, for example with respect to nodes or entities within the network. ARP information can include, for example, IP (Internet Protocol) address to MAC (Medium Access Layer) address mappings.

The bridge module 108 can also provide a persistent count of change events or delta events in the network, to the “changes” module 100 or element 100, which can be or include a file. The persistent count in the module 100 can be cleared upon completion of a discovery operation. The module 100 can be used in conjunction with change-based rediscovery operations. For example, if discovery or monitoring processes in or under the control of the bridge module 108 are shut down or otherwise disabled, then when they are restarted the bridge module 108 can access the module 100 to obtain the count use it as a starting point instead of beginning at zero.

The bridge module 108 can check or update handshaking variables, for example via the link 154 and the database 116. For example, the bridge module 108 can update one or more handshaking variables to indicate it has finished complying with a request, for example a request to output information regarding changes in the network since a last network topology discovery operation. In an exemplary embodiment, the bridge module 108 can indicate to the module 112 via the link 158 that the bridge module 108 has finished complying with a request, and the module 112 can update one or more handshaking variables (for example in the database 116 via the link 130) accordingly.

The rediscovery check module 114 can trigger itself (as indicated by the loop 146) at periodic intervals (for example, every five minutes, or at any other interval) to check the count of changes or delta events in the network against the threshold. In an exemplary embodiment, the rediscovery check module 114 can obtain both the count value and the threshold value from the network table 122, and send an alert to the bridge module 108 when the threshold is exceeded. If a network topology discovery operation is already in progress, or if delta or change-based discovery is not configured (for example, when deactivated by a user via the GUI 120) the rediscovery check module 114 can omit alerting the bridge module 108. The rediscovery check module 114 can also update and read handshaking variable(s) value(s) via the link 148 and the database 116 (including for example the database table 122). For example, the handshaking variable(s) can be updated whenever a module makes a request of the bridge module 108. The rediscovery check module 114 can determine whether a network topology discovery operation is in progress by checking data in the database 116, for example by checking the value of the M_DiscoActive variable or flag entry in the database table 122. The handshaking variable can be the M_DiscoActive variable, so that the rediscovery check module 114, the discovery interval module 110, or any other module can check the handshaking variable to find out whether a discovery operation is in progress and thereby avoid interrupting or disrupting an active discovery operation. The rediscovery check module 114 can also check another handshaking variable or value, for example the M_NNMDumpRequestState variable or value in the database table 122, to discern and avoid overriding an outstanding request to the bridge module 108 (for example from the discovery interval module 110 or the rediscovery check module 114) to output information regarding changes in the network since a last network topology discovery operation, for example to the modules 102, 104. This can prevent or avoid conflicting or simultaneous requests by the modules 110, 114.

In an exemplary embodiment, if a request to the bridge module 108 to output seed information such as information regarding changes in the network since a last network topology discovery operation, has been outstanding for an excessively long time, for example for a time period exceeding the value M_NNMDumpRequestTimeout in the database table 122, then another module such as either the rediscovery check module 114 or the discovery interval module 110 can override the incomplete request (for example via the links 150, 134 respectively) and proceed to initiate or enable a new network topology discovery operation.

The discovery interval module 110 can trigger itself (as indicated by the loop 160) at the end of a predetermined or configurable time period, at a predetermined or configurable time interval, or at a specific, predetermined or configurable point in time. The discovery interval module 110 can also update and check handshake information in the same fashion described with respect to the rediscovery check module 114.

The modules 112, 118 can also check and update handshaking variable(s), for example handshaking variables stored in the database 116 via the links 130, 128 respectively. For example, when the module 118 commences a network topology discovery operation, it can update a handshaking variable to indicate that the discovery operation is underway so that other modules can become aware by checking the handshaking variables and thereby avoid interrupting or disrupting the discovery operation. For example, the module 118 can set the flag M_DiscoActive in the database table 122 via the link 128.

In the database table 122, the variable M_NNMChangeCounter can indicate a current count of network changes detected by the bridge module 108 since the last network topology discovery operation. The variable M_ChangeThreshold can indicate a threshold number of detected network changes, for example above which the rediscovery check module 116 can enable or initiate a network topology discovery operation. The flag or variable M_DiscoActive can indicate whether a network topology discovery operation is currently in progress. The flag or variable M_NNMDumpRequestState can indicate whether there is an outstanding request to the bridge module 108 to provide information regarding detected network changes since the last network topology discovery operation. The variable M_NNMDumpRequestTimeout can indicate a maximum allowable time that a request to the bridge module 108 to provide information regarding detected network changes since the last network topology discovery operation, may remain outstanding before being susceptible to override. The variable M_NNMDumpSendTime can indicate a time at which an outstanding request to the bridge module 108 to provide information regarding detected network changes since the last network topology discovery operation, was first made. The M_NNMDumpSendTime variable can be used together with the M_NNMDumpRequestTimeout, for example with a current time, to determine whether the time period represented by the M_NNMDumpRequestTimeout value has been exceeded.

The flag or variable M_TimedRediscoFlag shown in the database table 122 can indicate whether timed activation of a network topology rediscovery operation is active. For example, the discovery interval module 110 can check the flag M_TimedRediscoFlag, and if it is set to indicate active, then the discovery interval module 110 will send notification to the bridge module 108 via the link 136 that a discovery interval time period or time interval has expired, and thereby enable or initiate a network topology discovery or rediscovery operation. If the M_TimedRediscoFlag flag is set to indicate inactive, then the discovery interval module 110 will not alert the bridge module 108.

The flag or variable M_ChangeRediscoFlag shown in the database table 122 can indicate whether change-based activation of a network topology rediscovery operation is active. For example, the rediscovery check module 114 can check the flag M_ChangeRediscoFlag, and if it is set to indicate active, then the rediscovery check module 114 will send notification to the bridge module 108 via the link 136 that a threshold number of changes in the network has been exceeded, and thereby enable or initiate a network topology discovery or rediscovery operation. If the M_ChangeRediscoFlag flag is set to indicate inactive, then the rediscovery check module 114 will not alert the bridge module 108.

At least some of the functions of the bridge module 108 shown in FIG. 1 can be performed using the following pseudocode:

```
// PSEUDO-CODE:
// This pseudo-code contains portions specifically
// relevant to rediscovery. It is one of many pieces of
// the ovet_bridge process or bridge module 108.
// The queryThreadfn( ) function handles the incoming requests,
// specifically from the stitchers or modules of the ovet_disco or discovery
process
// (e.g., the modules 110, 114)
// asking it to dump info in preparation for a rediscovery.
//
// The exportNNMInfo( ) function exports the hosts.nnm and arp.nnm
// files (as well as any others needed).
//
// Another thread of ovet_bridge is responsible for
// the interception of topology delta events in the network
// and the associated update of the persistent and in-memory
// change counter (.changes file, and m_NNMChangeCounter).
// It tracks by intercepting events associated with the
// monitoring of the network topology changes.
//-----------------------------------------------------------
//
// queryThreadfn function
//
// This function is of a type passed to a
// thread pool which responds to queries on the Adapt
// subject. For example, when a rediscovery stitcher tells
// the bridge that it is time to dump info for rediscovery.
//
//-----------------------------------------------------------
ThreadFn queryThreadFn;
const char *EXPORT_QUERY = “delete from nnm.info;”;
void
*queryThreadFn(void *arg)
{
        //
        // pull a refernce to the spool
        //
        ServPool *spool = (ServPool *)arg;
        for(;;) // loop
        {
            // step 1 lock the spool's work queue
            // step 2 wait for work while there is none
            // if not shutting down
            if (spool is shutting down)
            {
                // exit.
                spool->WorkUnLock( );
                return( arg );
            }
            // get the work from the pool.
            CBridgeQueryInfo *wrk = (CBridgeQueryInfo
*)spool->NextWork( );
            // open the queues
            if(spool->WorkDetails( ) == 0)
            {
                // signal no work left
                spool->SignalEmpty( );
            }
            // unlock spool work mutex
            // copy the query
            // allowing for NULL term
            //
    unsigned int datumSize;
    const void *datumData;
    Status status = wrk->Query( )->getOpaque(STRING_FIELD,
                    datumData, datumSize);
    if (status != OK)
    {
          // Fatal Error on the bus.
    } // Otherwise...
            // Receiving query.
            // Transfer what came in on the bus to a query string:
            char *query = NULL;
            query = (char *)malloc((datumSize + 1)*sizeof(char));
            memset((void *)query,0,((datumSize + 1)*sizeof(char)));
            memcpy((void *)query, datumData, datumSize);
            //////////////////
            // Compare the incoming query with the string representing
            // EXPORT_QUERY to see if they are one in the same.
            int eQuerySize = (strlen(EXPORT_QUERY))*
            (sizeof(char));
            if (!memcmp(query, EXPORT_QUERY, eQuerySize)) {
                // valid string, do the data export!
                // also reset the delta tracking value to 0.
                // and acknowledge the query was received.
                exportNNMInfo( );
                resetChangeCount( );
                setQueryReceived( );
                // Now handshake with the ovet_disco or discovery
process by triggering
                // the execution of NNMTopoDumpComplete.stch.
                triggerDumpComplete( );
            } else {
                    // The incoming message didn't match
                    // EXPORT_QUERY, so it wasnt a request to
                    // dump info.
            }
            delete wrk;
        }
}
```

At least some of the functions of the discovery interval module or stitcher 110 shown in FIG. 1 can be performed using the following pseudocode:

```
// PSEUDO-CODE:
// Stitcher DiscoveryInterval
// ===========================
//
// A timed stitcher or module (with configurable frequency) that kicks off a
full
// rediscovery every time it is executed (given that the discovery process
// is not still active at the time of execution).
//
StitcherTrigger
{
    // Executed on a timed frequency.
                // Configurable. Default is daily.
            TimedTrigger
            (
                (m_HourInterval)
                values
                (24);
            );
}
StitcherRules
{
                // Check the rediscovery database table to see if the
                // user wants automatic timed rediscovery active:
```

| | |
|---|---|
| int wants_redisco = 1; | // Assume it is wanted |

// unless we know otherwise.

```
                wants_redisco =
            (
                    “select m_TimedRediscoFlag from
                    disco.redisco;”
            );
                // Procede only if timed rediscovery is on.
            if (wants_redisco == 1)
            {
        // Check if discovery is still active. If so, dont
        // rediscovery at this time.
            int isActive = 1; // Assume it is active
                            // unless we know otherwise.
            isActive=
        (
            “select m_DiscoActive from disco.redisco;”
        );
            if (isActive != 1)
            {
                    int reqState = 0;
    reqState=
                (
                        “select m_NNMDumpRequestState from
                        disco.redisco;”
            );
                    int timeout = 0;
            timeout=
                (
                        “select m_NNMDumpRequestTimeout from
disco.redisco;”
            );
            int requestTime=
                (
                        “select m_NNMDumpSendTime from
                        disco.redisco;”
            );
            int timeExpired = 0;
                int timeNow = eval (int, ‘$TIME’);
                int timeSince = eval (int, ‘$timeNow −
                $requestTime’);
            if (timeSince >= timeout)
            {
            timeExpired = 1;
            }
            if ((reqState == 1) && (timeExpired == 1))
            {
                            // Force the rediscovery:
                    ExecuteStitcher(‘NNMTopoDumpComplete’);
            } else {
            // If a request for bridge to dump has already been made
            // by another stitcher (i.e. RediscoveryCheck), we dont want
            // clashing requests. If it was made by this stitcher, we
            // also dont want to keep updating the request time, or else
            // it may never exceed the timeout. So check for this first.
                    int requestState = 0;
            requestState=
                    (
                        “select m_NNMDumpRequestState from
disco.redisco;”
            );
                    if (requestState != 1)
                    {
                // Ask the bridge to begin dumping the updated
                // info for the upcoming discovery.
                SendToService
                        (
                            “RivAdapt”,
                            “delete from nnm.info;”
                        );
                // Update m_NNMDumpRequestState:
                    “update disco.redisco
                        set m_NNMDumpRequestState = 1;”
                // Update m_NNMDumpSendTime with the time this
                // request was sent:
                    “update disco.redisco
                        set m_NNMDumpSendTime = eval(time,
‘$TIME’);”
            }
    }
            } // fi disco not active.
        } // fi wants redisco.
}
```

At least some of the functions of the rediscovery check module or stitcher 114 shown in FIG. 1 can be performed using the following pseudocode:

```
// PSEUDO-CODE:
// Stitcher RediscoveryCheck
// ==========================
//
// A timed stitcher (with configurable frequency) that checks whether
// a rediscovery should take place by comparing (against a
// threshold, e.g. user-configured) the delta or difference(s) between the
// current network and the topology of the last discovery. This delta
// is based upon intercepted events representing change in the network,
// and is tracked by disco.redisco.m_NNMChangeCounter and persistently
// in the .changes file.
//
StitcherTrigger
{
    // Executed on a timed frequency.
                // Check the need for a delta-based
                // rediscovery every minute.
            ActOnTimedTrigger
            (
                (m_MinuteInterval)
                values
                (1);
            );
}
StitcherRules
{
                // Check if user wants change-based rediscovery.
                int wants_redisco = 1; // Assume it is wanted
                        // unless we know otherwise.
                wants_redisco =
            (
                    “select m_ChangeRediscoFlag from
                    disco.redisco;”
            );
            if (wants_redisco == 1)
            {
        // Check if discovery is still active. If so, dont
        // rediscovery at this time.
                    int isActive = 1; // Assume it is active
                            // unless we know otherwise.
                    isActive=
        (
            “select m_DiscoActive from disco.redisco;”
        );
            if (isActive != 1)
            {
                        int reqState = 0;
    reqState=
                    (
                                “select m_{—}
                                NNMDumpRequestState from
                                disco.redisco;”
            );
                        int timeout = 0;
            timeout=
                    (
                                “select m_{—}
                                NNMDumpRequestTimeout from
disco.redisco;”
            );
            int requestTime=
                    (
                                “select m_{—}
                                NNMDumpSendTime from
                                disco.redisco;”
            );
            int timeExpired = 0;
                    int timeNow = eval(int, ‘$TIME’);
                            if (requestTime == 1) // No request
has yet been made.
                            { // 1 is the initial schema value.
                                requestTime = timeNow;
                            }
                        int timeSince = eval (int, ‘$timeNow −
                        $requestTime’);
                        if (timeSince > = timeout)
                {
                timeExpired = 1;
                }
                if ((reqState == 1) && (timeExpired == 1))
                {
                                    // Force the rediscovery:
        ExecuteStitcher(‘NNMTopoDumpComplete’);
    } else {
    // Check the change count against the acceptable threshold:
                int changes = 0;
    changes=
                (
                    “select m_NNMChangeCounter from
                    disco.redisco;”
    );
    int threshold = 0;
    threshold =
                (
                    “select m_ChangeThreshold from disco.redisco;”
    );
    // NOTE: the user can configure this threshold in the schema.
            // If the threshold has been exceeded, while discovery is not
            // currently still active: then
            // we're commencing a full rediscovery. If not, carry on.
            // But if a request for bridge to dump has already been made
            // by this or another stitcher (i.e. DiscoveryInterval),
            // we dont want clashing requests. So check for this first.
            if (changes > = threshold)
            {
                    if (reqState != 1)
                    {
                    // Ask the bridge to begin dumping the updated
                    // info for the upcoming discovery.
                    SendOQLToService
                        (
                                “RivAdapt”,
                                “delete from nnm.info;”
                        );
                        // Update m_NNMDumpRequestState:
                            “update disco.redisco
                        set m_NNMDumpRequestState = 1;”
                // Update m_NNMDumpSendTime with the time this
                // request was sent:
                    “update disco.redisco
                    set m_NNMDumpSendTime = eval(time,
‘$TIME’);”
                }
            }
        }
        } // fi disco not active.
    } // fi wants redisco.
}
```

At least some of the functions of the module or full discovery stitcher 118 shown in FIG. 1 can be performed using the following pseudocode:

| // PSEUDO-CODE: | |
|---|---|
| ///////////////////////////////////////////////////////////////////// | |
| // | |
| // | Full Discovery Stitcher |

```
//
//////////////////////////////////////////////////////////////////////
StitcherTrigger
{
        // This is called from the FinalPhase stitcher, during
        // rediscovery.
}
StitcherRules
{
        // Go into BlackoutState.
        // delete data from almost all databases in the discovery
        // data flow. (keep nodes known to be pending discovery)
        //
        // Delete data from any cache related to SNMP data,
        // since new discovery will be fresh.
        // Once we refresh our finder(s) below, we will begin
        // a new discovery. Mark this time as the start
        // of a rediscovery (type 2).
        ExecuteStitcher(‘UpdateStartTime’, 2);
        //
        // Reset the Finder(s), which will cause it to
        // look for the new file data, including the newly
        // dumped hosts.nnm.
        DiscoRefresh
        (
            “FileFinder”
        );
        // Reset discovery status tracking variables
        // Exit BlackOutState; set DiscoveryMode, reset
        // the discovery cycle to the beginning
        // set Discovery to active, so that a discovery
        // wont be interrupted by a rediscovery until
        // after it completes and produces a topology.
        //
            “update disco.redisco set
                m_DiscoActive = 1;”
        // Copy any other nodes pending a discovery to any other
        // finders.
        // A full discovery is underway.
}
```

At least some of the functions of the module or NNM topo dump complete stitcher 112 shown in FIG. 1 can be performed using the following pseudocode:

```
// PSEUDO-CODE:
//
// Stitcher NNMTopoDumpComplete
// =============================
//
// An on-demand stitcher that will initiate the full discovery and reset
// the dump request state when a valid dump request is completed.
//
UserDefinedStitcher
{
    StitcherTrigger
    {
        // Executed upon insertion into stitchers.actions.
        // The ovet_bridge will initiate that, upon completing
                // its topo data dump.
                // Note that for robustness, it can also be executed
                // from RediscoverCheck.stch and
                DiscoveryInterval.stch in
                // the case that the dump is stalled longer than the
                // timeout value or if the dump completing signal isnt
                // caught.
            ActOnDemand( );
    }
    StitcherRules
    {
                int requestState = 0;
        requestState=
                (
                        “select m_NNMDumpRequestState from
                        disco.redisco;”
            );
            // There should be an outstanding request in order to
            procede.
            if (requestState != 0)
            {
                // reset the request state:
                        “update disco.redisco
                            set m_NNMDumpRequestState = 0;”
                // initiate a full discovery:
                    ExecuteStitcher(‘FullDiscovery’);
            }
    }
}
```

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth). Elements referred to as modules can be implemented in different ways, including for example agents. Those skilled in the art will recognize that functions performed by the modules disclosed herein, can be performed using greater or fewer modules, or any appropriate software device that will perform the disclosed functions.

Those skilled in the art will also appreciate that a computer program or software, including instructions for causing a computer, computing device or system to perform the methods or processes disclosed herein, can be stored on a machine-readable medium.

Those skilled in the art will also appreciate that the elements and methods or processes described herein can be implemented using a microprocessor, computer, or any other computing device, and can be implemented in hardware and/or software, in a single physical location or in distributed fashion among various locations or host computing platforms. The agents can be implemented in hardware and/or software at any desired or appropriate location.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for monitoring a network, comprising:
detecting changes in the network; and
initiating discovery of the topology of the network when a number of detected changes in the network exceeds a threshold.

2. The method of claim 1, wherein the detected changes are changes in topology or configuration of the network.

3. The method of claim 1, wherein the detected changes include changes other than addition of a node to the network and deletion of a node from the network.

4. The method of claim 1, comprising:
initiating discovery of a topology of the network upon expiration of a predetermined time period.

5. The method of claim 4, wherein the predetermined time period is specified by a user.

6. The method of claim 4, wherein the initiating is initially performed based on the detected changes.

7. The method of claim 1, wherein the threshold is specified by a user.

8. System for monitoring a network, comprising:
means for detecting changes in the network; and
means for initiating discovery of the topology of the network when a number of detected changes in the network exceeds a threshold.

9. The system of claim 8, comprising:
means for initiating discovery of a topology of the network upon expiration of a predetermined time period.

10. The system of claim 9, wherein the predetermined time period is specified by a user.

11. The system of claim 8, wherein the detected changes are changes in topology or configuration of the network.

12. The system of claim 8, wherein the detected changes include changes other than addition of a node to the network and deletion of a node from the network.

13. The system of claim 8, wherein the initiating is initially performed based on the detected changes.

14. A machine readable medium comprising a computer program for causing a computer to:
detect changes in the network; and
initiate discovery of the topology of the network when a number of detected changes in the network exceeds a threshold.

15. The medium of claim 14, wherein the computer program causes the computer to:
initiate discovery of a topology of the network upon expiration of a predetermined time period.

16. The medium of claim 15, wherein the predetermined time period is specified by a user.

17. The medium of claim 15, wherein the computer program causes the computer to:
determine when the predetermined time period elapses.

18. The medium of claim 14, wherein the computer program causes the computer to:
count the detected changes; and
determine when the number of detected changes exceeds the threshold.

19. The medium of claim 18, wherein the computer program causes the computer to:
initiate discovery of the topology of the network based on the detected changes.

20. The medium of claim 14, wherein the detected changes are changes in topology or configuration of the network.

21. The medium of claim 14, wherein the detected changes include changes other than addition of a node to the network and deletion of a node from the network.
